(19) United States
(12) Patent Application Publication
(10) Pub. No.: US 2024/0162486 A1
(43) Pub. Date: May 16, 2024

(54) BATTERY

(71) Applicant: Panasonic Intellectual Property Management Co., Ltd., Osaka (JP)

(72) Inventors: TAKASHI OTO, Osaka (JP); MASAHISA FUJIMOTO, Osaka (JP)

(21) Appl. No.: 18/423,907

(22) Filed: Jan. 26, 2024

Related U.S. Application Data
(63) Continuation of application No. PCT/JP2022/023789, filed on Jun. 14, 2022.

(30) Foreign Application Priority Data
Aug. 10, 2021 (JP) 2021-130971

(51) Int. Cl. H01M 10/0562; H01M 10/0525

(52) U.S. Cl. CPC H01M 10/0562; H01M 10/0525; H01M 2300/002

(57) ABSTRACT

A battery includes a first electrode; a second electrode; and a solid electrolyte layer disposed between the first electrode and the second electrode. The solid electrolyte layer contains a first solid electrolyte. The first electrode includes: a substrate including a porous body; and an active material layer disposed on a surface of the substrate. The active material layer contains Bi. The first solid electrolyte contains a halide solid electrolyte.

### BACKGROUND

### 1. Technical Field

The present disclosure relates to a battery.

### 2. Description of the Related Art

Lithium secondary batteries have been a subject of active research and development in recent years, and their battery characteristics, such as charge-discharge voltage, charge-discharge cycle life, and storage properties, are strongly dependent on electrodes used therein. Thus, battery characteristics have been improved by improving electrode active materials.

For example, lithium secondary batteries that use electrodes containing aluminum, silicon, tin, or the like that electrochemically alloys with lithium during charging have been proposed from early days. Japanese Patent No. 4898737 discloses a lithium secondary battery equipped with a negative electrode containing a negative electrode material made of an alloy containing silicon, tin, and a transition metal, a positive electrode, and an electrolyte.

Japanese Patent No. 3733065 discloses a lithium secondary battery equipped with a negative electrode that uses, as an active material, a silicon thin film formed on a current collector, a positive electrode, and an electrolyte.

Another example of the metal that alloys with lithium is bismuth (Bi). YAMAGUCHI, Hiroyuki, “Amorphous Polymeric Anode Materials from Poly(acrylic acid) and Metal Oxide for Lithium Ion Batteries”, Mie University, doctoral dissertation, 2015 (hereinafter, this literature is simply referred to as YAMAGUCHI), discloses a negative electrode that is produced by using a Bi powder and that contains Bi as a negative electrode active material.

### SUMMARY

One non-limiting and exemplary embodiment provides a battery that has a structure suitable for improving the charge-discharge characteristics.

In one general aspect, the techniques disclosed here feature a battery that includes a first electrode, a second electrode, and a solid electrolyte layer disposed between the first electrode and the second electrode, in which the solid electrolyte layer contains a first solid electrolyte, the first electrode includes: a substrate including a porous body; and an active material layer disposed on a surface of the substrate, the active material layer contains Bi, and the first solid electrolyte contains a halide solid electrolyte.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a structural example of a battery according to an embodiment of the present disclosure;

FIG. 2 is a schematic partially enlarged cross-sectional view of a structural example of a first electrode of a battery according to an embodiment of the present disclosure;

FIG. 3 is a schematic partially enlarged cross-sectional view of a modification example of the structure of a first electrode of a battery according to an embodiment of the present disclosure;

FIG. 4 is a graph showing the results of a charge-discharge test of test cells of Examples 1 and 2; and

FIG. 5 is a graph showing the results of a charge-discharge test of test cells of Reference Examples 1 and 2.

### DETAILED DESCRIPTIONS

### Underlying Knowledge Forming Basis of the Present Disclosure

As described in the “Background Art” section, battery characteristics of lithium secondary batteries have been improved by improving electrode active materials.

When lithium metal is used as a negative electrode active material, a lithium secondary battery that has high energy densities per weight and per volume is obtained. However, in a lithium secondary battery having this structure, lithium dendrites are deposited during charging. Since some of the deposited lithium metal reacts with the electrolyte solution, there have been issues of low charge-discharge efficiency and poor cycle characteristics.

To address this, a proposal to use carbon, in particular, graphite, as a negative electrode has been made. In a negative electrode containing carbon, charging and discharging are realized by lithium intercalation into and deintercalation from carbon. When a negative electrode has such a structure, the charge-discharge mechanism does not cause deposition of lithium metal dendrites. In addition, a lithium secondary battery that has a negative electrode having such a structure has excellent reversibility due to topotactic reactions and has nearly 100% charge-discharge efficiency. Due to these features, lithium secondary batteries having negative electrodes containing carbon, in particular, graphite, have been put to practical use. However, the theoretical capacity density of graphite is 372 mAh/g, which is about one tenth of the theoretical capacity density of lithium metal, 3884 mAh/g. Thus, the active material capacity density of a negative electrode containing graphite is low. Furthermore, since the actual capacity density of graphite is nearly as high as the theoretical capacity density, increasing the capacity of the negative electrode containing graphite has reached a limit.

To address this, lithium secondary batteries that use electrodes containing aluminum, silicon, tin, or the like that electrochemically alloys with lithium during charging have been proposed from early days. The capacity density of a metal that alloys with lithium is far larger than the capacity density of graphite. In particular, the theoretical capacity density of silicon is high. Thus, an electrode containing a material, such as aluminum, silicon, or tin, that alloys with lithium has a good prospect as a negative electrode for a high-capacity battery, and various types of secondary batteries that use such negative electrodes have been proposed (Japanese Patent No. 4898737).

However, a negative electrode that contains the aforementioned metal that alloys with lithium expands upon lithium intercalation and contracts upon lithium deintercalation. Repeating such expansion and contraction during charging and discharging breaks the alloy serving as the electrode active material into fine particles due to charging and discharging and deteriorates the current collecting properties of the negative electrode; thus, sufficient cycle characteristics have not been obtained. The following attempts have been made to address these issues. For example, in one attempt, silicon is sputter-deposited or vapor-deposited on a roughened surface of a current collector, or tin is deposited by electroplating (Japanese Patent No. 3733065). According to this attempt, the active material, in other words, a metal that alloys with lithium, forms a thin film and closely adheres to the current collector, and thus current collecting properties are rarely degraded despite repeated expansion and contraction of the negative electrode caused by lithium intercalation and deintercalation.

However, the production cost for forming an active material by sputtering or vapor deposition as described above is high, and this approach is not practical. It is practical to form an active material by less costly electroplating; however, silicon is difficult to electroplate. Moreover, tin, which is easy to electroplate, has issues of poor discharge flatness and difficulty in using as an electrode of a battery.

Another metal that alloys with lithium is bismuth (Bi). Bi forms compounds, LiBi and Li₃Bi, with lithium (Li). The potential of LiBi is not much different from the potential of Li₃Bi. In contrast, tin, which has poor discharge flatness, forms several compounds with lithium, and the potential of the compounds significantly differ from one another. In other words, unlike tin, Bi does not have properties of forming multiple compounds with lithium having significantly different potentials from one another. Thus, an electrode that contains Bi as the active material has excellent discharge flatness due to the flat potential. Thus, an electrode that contains Bi as the active material is considered to be suitable as an electrode of a battery.

However, Bi has poor malleability and ductility and is difficult to produce metal sheets or foils therefrom; thus, the obtained form is either beads or powder. Thus, an electrode produced by applying a Bi powder to a current collector is being explored as the electrode containing Bi as the active material. However, the electrode produced by using a Bi powder breaks into fine particles as charging and discharging are repeated, and the current collecting properties are thereby degraded; thus, sufficient cycle characteristics have not been obtained. In YAMAGUCHI, an electrode containing Bi as an active material is prepared by using a Bi powder and polyvinylidene fluoride (PVdF) or polyimide (PI) as a binder. In YAMAGUCHI, a battery produced by using this electrode is charged and discharged. However, the results of the initial charge-discharge curve and the cycle characteristics of the produced electrode are very poor. Although measurement is taken at a very low-rate equivalent to 0.042 IT, the initial charge-discharge efficiency is low, the cycle deterioration is extensive, and the battery is far from practical application. Regarding the cycle deterioration, YAMAGUCHI points out that the active material becomes pulverized as the Bi active material expands during Li intercalation and contracts during Li deintercalation, and presumably thus the electron conduction paths no longer form and the capacity decreases.

The present inventors have focused on Bi which does not have a property of forming, with Li, multiple compounds having large potential differences and which has excellent discharge flatness, and have conducted extensive studies on batteries with which cycle characteristics can be improved. As a result, the present inventors have found that, when Bi serving as an active material is formed on a surface of a porous substrate for the purpose of improving the specific surface area of the electrode in contact with the electrolyte, a battery that uses a solid electrolyte as the electrolyte exhibits improved cycle characteristics compared to a battery that uses an electrolyte solution, and thus arrived at the present disclosure.

### Summary of One Aspect of the Present Disclosure

A battery according to a first aspect of the present disclosure includes:
a first electrode,
a second electrode, and
a solid electrolyte layer disposed between the first electrode and the second electrode,
in which the solid electrolyte layer contains a first solid electrolyte,
the first electrode includes:
   a substrate including a porous body; and
   an active material layer disposed on a surface of the substrate,
the active material layer contains Bi, and
the first solid electrolyte contains a halide solid electrolyte.

When Bi serving as an active material is formed on a surface of a porous substrate for the purpose of improving the specific surface area of the electrode in contact with the electrolyte, a battery that uses a solid electrolyte as the electrolyte exhibits improved cycle characteristics compared to a battery that uses an electrolyte solution. As described above, the battery of the first embodiment has a structure suitable for improving the charge-discharge characteristics.

According to a second aspect of the present disclosure, for example, in the battery according to the first aspect, the active material layer may contain elemental Bi.

According to the battery of the second aspect, the charge-discharge characteristics can be further improved.

According to a third aspect of the present disclosure, for example, in the battery according to the first or second aspect, the active material layer may contain the Bi as a main component of an active material.

The battery of the third aspect has a higher capacity and improved charge-discharge characteristics.

According to a fourth aspect of the present disclosure, for example, in the battery according to the third aspect, the active material layer may contain substantially only the Bi as the active material.

The battery of the fourth aspect has a higher capacity and improved charge-discharge characteristics.

According to a fifth aspect of the present disclosure, for example, in the battery of any one of the first to fourth aspects, the active material layer may contain at least one selected from the group consisting of LiBi and Li₃Bi.

The battery of the fifth aspect has a higher capacity and improved charge-discharge characteristics.

According to a sixth aspect of the present disclosure, for example, in the battery of any one of the first to fifth aspects, the active material layer may be free of an electrolyte.

The battery of the sixth aspect has a higher capacity and improved charge-discharge characteristics.

According to a seventh aspect of the present disclosure, for example, in the battery of any one of the first to sixth aspects, the substrate may contain at least one selected from the group consisting of Cu and Ni.

The battery of the seventh aspect has a higher capacity and improved charge-discharge characteristics.

According to an eighth aspect of the present disclosure, for example, in the battery of any one of the first to seventh aspects, the active material layer may be a plating layer.

The battery of the eighth aspect has a higher capacity and improved charge-discharge characteristics.

According to a ninth aspect of the present disclosure, for example, in the battery of any one of the first to eighth aspects, the halide solid electrolyte may be substantially free of sulfur.

The battery of the ninth aspect has a higher capacity and improved charge-discharge characteristics.

According to a tenth aspect of the present disclosure, for example, in the battery of any one of the first to ninth aspects, the first solid electrolyte may contain a sulfide solid electrolyte.

The battery of the tenth has a higher capacity and improved charge-discharge characteristics.

According to an eleventh aspect of the present disclosure, for example, in the battery of any one of the first to tenth aspects, the first electrode may further include a second solid electrolyte in contact with the active material layer.

The battery of the eleventh aspect has a higher capacity and improved charge-discharge characteristics.

According to a twelfth aspect of the present disclosure, for example, in the battery of any one of the first to eleventh aspects, the first electrode may be a negative electrode, and the second electrode may be a positive electrode.

The battery of the twelfth aspect has a higher capacity and improved charge-discharge characteristics.

### Embodiments of the Present Disclosure

Hereinafter, the embodiments of the present disclosure are described with reference to the drawings. All of the descriptions below are comprehensive or specific examples. The numerical values, compositions, shapes, film thickness, electrical characteristics, secondary battery structure, etc., indicated below are merely examples, and do not limit the present disclosure.

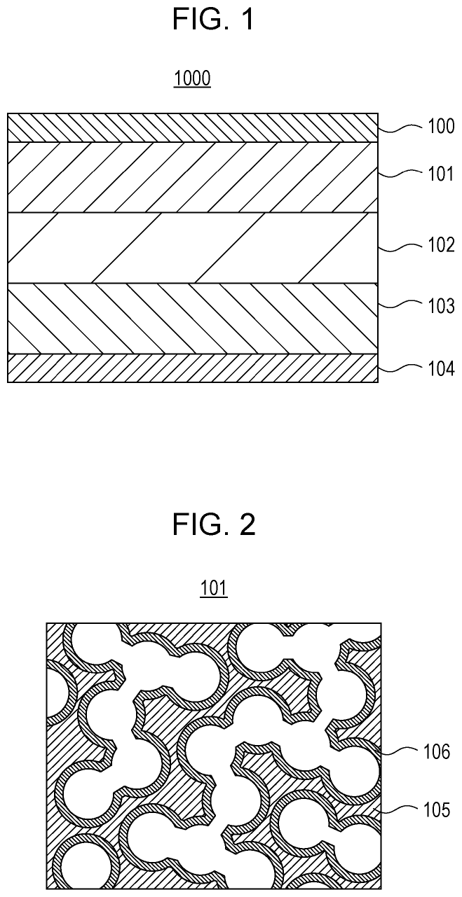

FIG. 1 is a schematic cross-sectional view of a structural example of a battery 1000 according to an embodiment of the present disclosure.

The battery 1000 has a first electrode 101, a second electrode 103, and a solid electrolyte layer 102 disposed between the first electrode 101 and the second electrode 103. FIG. 2 is a schematic partially enlarged cross-sectional view of a structural example of the first electrode 101 of the battery 1000 according to an embodiment of the present disclosure. As illustrated in FIG. 2, the first electrode 101 includes a substrate 105 including a porous body, and an active material layer 106 disposed on a surface of the substrate 105. The active material layer 106 contains Bi. The active material layer 106 contains, for example, elemental Bi as Bi.

As illustrated in FIG. 1, the battery 1000 of the present embodiment may further include, for example, a first current collector 100 in contact with the first electrode 101. In addition, the battery 1000 of the present embodiment may further include, for example, a second current collector 104 in contact with the second electrode 103. Electricity can be highly efficiently obtained from the battery 1000 by including the first current collector 100 and the second current collector 104.

In the first electrode 101 of the battery 1000, the active material layer 106 containing the Bi is formed on a surface of the substrate 105 including a porous body. For example, as illustrated in FIG. 2, the active material layer 106 is also formed on inner walls of pores in the substrate 105. Thus, regarding the area at which the active material and the solid electrolyte can be in contact with each other in the battery 1000, the area of the active material layer 106 is larger when the active material layer 106 is formed on a surface of the substrate 105 including a porous body, than when the active material layer 106 is formed on a surface of a foil substrate. Thus, if the same amount of the active material is to be provided on the substrate of the battery 1000, a thinner active material layer 106 can be formed than when the active material layer 106 is formed on a foil substrate. As a result, in the active material layer 106 containing Bi, the load characteristics attributable to the solid phase diffusion of Li ions are improved, for example, the load characteristics during discharging are improved. Thus, according to the battery of the present embodiment, the charge-discharge characteristics can be improved, in particular, the initial efficiency can be improved. As described above, the battery 1000 of the present embodiment has a structure suitable for improving the charge-discharge characteristics.

Note that in the first electrode 101 illustrated in FIG. 2, the active material layer 106 is formed as a thin film on inner walls of the pores in the substrate 105, and the pores are present to provide a relatively high porosity. However, the structure of the first electrode 101 is not limited to this. For example, the first electrode 101 may have an active material layer 106 substantially filling the insides of the pores in the substrate 105 and may have a low porosity. Even when the first electrode 101 has this structure, the boundary between the substrate 105 and the active material layer 106 can be clearly distinguished, and it can be said that, in the first electrode 101, the substrate 105 includes a porous body and the active material layer 106 is formed on a surface of the substrate 105. The active material layer 106 may be formed on some parts of inner walls of multiple pores or may be formed on substantially all parts of inner walls of the pores.

The battery 1000 is, for example, a lithium secondary battery. Hereinafter, an example in which the metal ions that are intercalated into and deintercalated from the active material layer 106 in the first electrode 101 and the second electrode 103 during charging and discharging of the battery 1000 are lithium ions is described.

The substrate 105 includes, as mentioned above, a porous body. In this description, a porous body refers to a structure that has multiple pores that include open pores that open to the outside. Examples of the porous body in this description include a mesh and a porous structure. A porous structure is constituted by a porous material having multiple pores, and the size of pores is not particularly limited. An example of the porous structure is a foam. The porous structure may be a three-dimensional network structure in which the pores are in communication with each other. In this description, the “pores” refer to those with insides filled with an active material layer or free of an active material layer. In other words, those pores that have insides filled with an active material layer are also considered “pores”.

The substrate 105 has, for example, electrical conductivity. The substrate 105 may include a conductive material, such as a metal, or a porous body (for example, a resin foam) made of a non-conductive material, such as a resin, having a surface covered with a conductive film made of a conductive material. The substrate 105 may be, for example, a metal mesh or a porous metal. The substrate 105 can function as a current collector for the first electrode 101. In other words, when there is a first current collector 100, for example, the first current collector 100 and the substrate 105 function as the current collectors for the first electrode 101. When there is no first current collector 100, for example, the substrate 105 functions as a current collector for the first electrode 101.

The substrate 105 may contain at least one selected from the group consisting of Cu and Ni. The substrate 105 may be, for example, a metal mesh or a porous metal. The substrate 105 may be, for example, a nickel mesh or a porous nickel.

As mentioned above, the active material layer 106 contains Bi. The active material layer 106 may contain Bi as a main component. Here, the phrase “the active material layer 106 contains Bi as a main component” is defined as that “the Bi content in the active material layer 106 is greater than or equal to 50 mass %”. The Bi content in the active material layer 106 can be determined by, for example, performing elemental analysis by energy dispersive X-ray spectroscopy (EDX) to confirm the presence of Bi in the active material layer 106 and then performing Rietveld analysis on the X-ray diffraction results of the active material layer 106 to calculate the ratios of the compounds contained therein.

According to the aforementioned features, improved charge-discharge characteristics are obtained.

The active material layer 106 that contains Bi as a main component may be constituted by a thin film of Bi (hereinafter, referred to as a “Bi thin film”).

The active material layer 106 constituted by a Bi thin film can be produced by, for example, electroplating. A method for producing a first electrode 101 by producing the active material layer 106 by electroplating is, for example, as follows.

First, a substrate for electroplating is prepared. A porous body that can constitute the substrate 105 when the first electrode 101 is formed is used as the substrate for electroplating. Examples of the substrate for electroplating include a metal mesh and a porous metal. For example, a nickel mesh or porous nickel may be used as the substrate for electroplating. Since the porous body used for the substrate for electroplating may be any as long as the porous body can serve as the substrate 105 upon formation of the first electrode after the processes such as electroplating and pressing, the structure thereof is not particularly limited and can be selected as appropriate according to the structure of the first electrode 101 to be formed. In one example, a porous body used for the substrate for electroplating may have, for example, a specific surface area greater than or equal to 0.014 m²/cm³ and less than or equal to 0.036 m²/cm³.

For example, a nickel mesh is prepared as the substrate for electroplating. After the nickel mesh is preliminarily degreased with an organic solvent, the nickel mesh is immersed in an acidic solvent to perform degreasing and activate the nickel mesh surface. The activated nickel mesh is connected to a power supply so that current can be applied. The nickel mesh connected to the power supply is immersed in a bismuth plating bath. For example, an organic acid bath containing Bi³⁺ ions and an organic acid is used as the bismuth plating bath. Next, electrical current is applied to the nickel mesh while the current density and application time are controlled so as to electroplate the nickel mesh surface with Bi. After electroplating, the nickel mesh is recovered from the plating bath, the mask is removed, and the nickel mesh is washed with pure water and dried. Through these steps, a Bi plating layer is formed on the surface of the nickel mesh. Here, the bismuth plating bath used in preparing the Bi plating layer is not particularly limited, and can be appropriately selected from known bismuth plating baths that can deposit elemental Bi thin films. For the bismuth plating bath, an organic sulfonic acid bath, a gluconic acid and ethylenediaminetetraacetic acid (EDTA) bath, or a citric acid and EDTA bath can be used as the organic acid bath. Furthermore, for example, a sulfuric acid bath can be used as the bismuth plating bath. Furthermore, additives may be added to the bismuth plating bath.

A Bi plating layer can be obtained as described above even when, for example, a porous nickel is used as the substrate for electroplating.

The active material constituted by a Bi thin film has, for example, a density greater than or equal to 6.0 g/cm³ and less than or equal to 9.8 g/cm³. The density of the active material constituted by the Bi thin film may be greater than or equal to 6.5 g/cm³ and less than or equal to 9.8 g/cm³ or may be greater than or equal to 7.0 g/cm³ and less than or equal to 9.8 g/cm³. The density of the active material constituted by the Bi thin film can be calculated by, for example, the Archimedes's principle. For example, when the active material layer 106 is constituted by a thin film consisting essentially of an active material, at least one portion of the thin film is taken out as a sample, and the density of the sample is calculated by, for example, the Archimedes's principle to obtain the density of the active material.

In the description below, the features of the battery 1000 of the present embodiment are described in more detail by using, as one example, the case in which the first electrode 101 is a negative electrode and the second electrode 103 is a positive electrode.

### First Electrode

As mentioned above, the first electrode 101 includes a substrate 105 including a porous body, and an active material layer 106 disposed on a surface of the substrate 105. The features of the substrate 105 and the active material layer 106 are as described above but are described below in more detail.

The first electrode 101 functions as a negative electrode. Thus, the active material layer 106 contains a negative electrode active material that has properties of intercalating and deintercalating lithium ions. The active material layer 106 contains Bi, and this Bi functions as a negative electrode active material.

Bi is a metal element that alloys with lithium. When Bi functions as a negative electrode active material, Bi alloys with lithium during charging, and lithium is intercalated as a result. In other words, in the active material layer 106, a lithium bismuth alloy is generated during charging of the battery 1000. The lithium bismuth alloy generated contains, for example, at least one selected from the group consisting of LiBi and Li₃Bi. In other words, during charging of the battery 1000, the active material layer 106 contains, for example, at least one selected from the group consisting of LiBi and Li₃Bi. During discharging of the battery 1000, the lithium bismuth alloy deintercalates lithium and returns to Bi.

Bi serving as a negative electrode active material undergoes the following reactions, for example, during charging and discharging of the battery 1000. Note that the examples of the reactions below are the examples in which the lithium bismuth alloy generated during charging is Li₃Bi.

Charging: Bi+3Li⁺+3e⁻→Li₃Bi

Discharging: Li₃Bi→Bi+3Li⁺+3e⁻

The active material layer 106 may contain substantially only Bi as the active material. In such a case, the battery 1000 can exhibit an improved capacity and improved cycle characteristics. Here, the “active material layer 106 contains substantially only Bi as the active material” means, for example, that the amount of the active materials other than Bi is less than or equal to 1 mass % of the active materials contained in the active material layer 106. The active material layer 106 may contain only Bi as the active material.

The active material layer 106 may be free of an electrolyte. For example, the active material layer 106 may be a layer composed of Bi and/or a lithium bismuth alloy generated during charging. The electrolyte referred here is a liquid or solid electrolyte that has lithium-ion conductivity.

The active material layer 106 may be disposed in direct contact with the surface of the substrate 105. When the battery 1000 includes a first current collector 100, the substrate 105 may be disposed in contact with the first current collector 100.

The active material layer 106 may have a thin film shape.

The active material layer 106 may be a plating layer. The active material layer 106 may be a plating layer disposed in direct contact with the surface of the substrate 105.

In other words, as described above, the active material layer 106 may be a Bi plating layer formed on the surface of the substrate 105.

When the active material layer 106 is a plating layer disposed in direct contact with the surface of the substrate 105, the active material layer 106 firmly adheres to the substrate 105. As a result, degradation of the current collecting properties of the first electrode 101 caused by repeated expansion and contraction of the active material layer 106 can be further reduced. Thus, the battery 1000 exhibits further improved charge-discharge characteristics. Furthermore, when the active material layer 106 is a plating layer, the active material layer 106 contains a high concentration of Bi, which alloys with lithium, and thus a further larger capacity can be realized.

The active material layer 106 may contain materials other than Bi and alloys containing Bi. Here, the alloys containing Bi are, for example, lithium bismuth alloys generated by the charging reaction (for example, LiBi and Li₃Bi).

The active material layer 106 may further contain a conductive material.

Examples of the conductive material include carbon materials, metals, inorganic compounds, and conductive polymers. Examples of the carbon materials include graphite, acetylene black, carbon black, Ketjen black, carbon whiskers, needle coke, and carbon fibers. Examples of the graphite include natural graphite and artificial graphite. Examples of the natural graphite include vein graphite and flake graphite. Examples of the metals include copper, nickel, aluminum, silver, and gold. Examples of the inorganic compound include tungsten carbide, titanium carbide, tantalum carbide, molybdenum carbide, titanium boride, and titanium nitride. These materials may be used alone or as a mixture of two or more.

The active material layer 106 may further contain a binder.

Examples of the binder include fluororesins, thermoplastic resins, ethylene propylene diene monomer (EPDM) rubber, sulfonated EPDM rubber, and natural butyl rubber (NBR). Examples of the fluororesins include polytetrafluoroethylene (PTFE), polyvinylidene fluoride (PVdF), and fluororubber. Examples of the thermoplastic resins include polypropylene and polyethylene. These materials may be used alone or as a mixture of two or more.

The thickness of the active material layer 106 is not particularly limited and may be, for example, greater than or equal to 0.1 μm and less than or equal to 100 μm.

The material for the substrate 105 is, for example, an elemental metal or an alloy. More specifically, an elemental metal or an alloy that contains at least one selected from the group consisting of copper, chromium, nickel, titanium, platinum, gold, aluminum, tungsten, iron, and molybdenum may be used. The substrate 105 may be composed of stainless steel.

The substrate 105 may contain at least one selected from the group consisting of copper (Cu) and nickel (Ni).

The structure of the substrate 105 is as mentioned above. The substrate 105 may be considered a current collector or a part of a current collector of the first electrode 101.

The thickness of the first electrode 101 may be greater than or equal to 10 μm and less than or equal to 2000 μm. In other words, the thickness of the entire substrate 105 including a porous body having a surface with the active material layer 106 formed thereon, may be greater than or equal to 10 μm and less than or equal to 2000 μm. When the first electrode 101 has such a thickness, the battery can operate at high output.

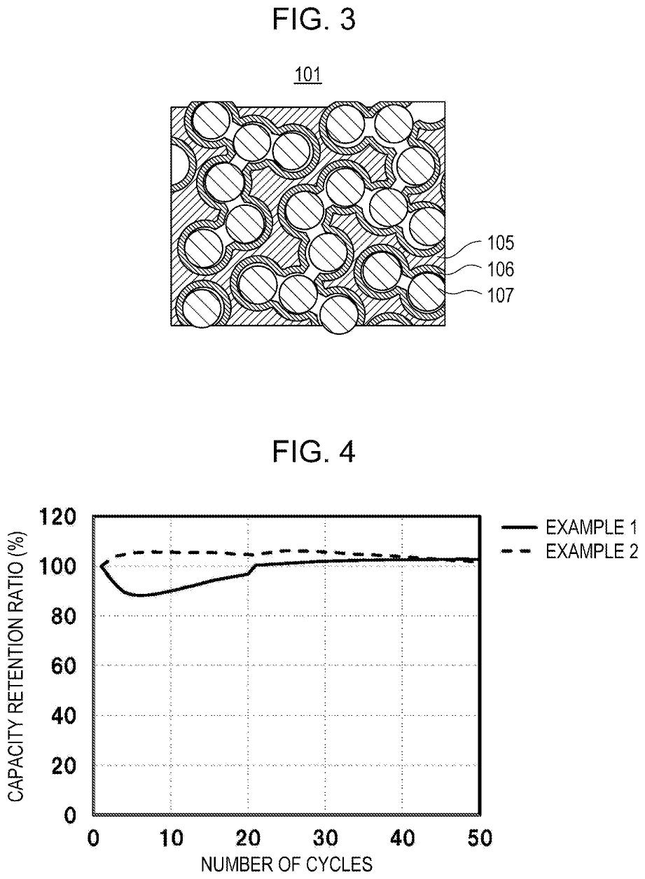

FIG. 3 is a schematic partially enlarged cross-sectional view of a modification example of the structure of a first electrode of a battery according to an embodiment of the present disclosure; As in the modification example illustrated in FIG. 3, the first electrode 101 may further include a second solid electrolyte 107 in contact with the active material layer 106. For example, the second solid electrolyte 107 may be contained in the pores in the substrate 105. Thus, regarding the area at which the active material and the solid electrolyte can be in contact with each other in the battery 1000, the area of the active material layer 106 is larger when the active material layer 106 is formed on a surface of the substrate 105 including a porous body, than when the active material layer 106 is formed on a surface of a foil substrate. Thus, if the same amount of the active material is to be provided on the substrate of the battery 1000, a thinner active material layer 106 can be formed than when the active material layer 106 is formed on a foil substrate. As a result, in the active material layer 106 containing Bi, the load characteristics attributable to the solid phase diffusion of Li ions are improved, for example, the load characteristics during discharging are improved. Thus, due to these features of the first electrode, the battery of the present embodiment can exhibit further improved charge-discharge characteristics.

Note that in the first electrode 101 illustrated in FIG. 3, the active material layer 106 is formed as a thin film on inner walls of the pores in the substrate 105, and the inside region of the active material layer 106 is substantially filled with the second solid electrolyte 107. As such, in this first electrode 101, the insides of the pores in the substrate 105 may be substantially filled with the active material layer 106 and the second solid electrolyte 107, and the porosity may be low. Even when the first electrode 101 has this structure, the boundary between the substrate 105 and the active material layer 106 can be clearly distinguished, and it can be said that, in the first electrode 101, the substrate 105 includes a porous body and the active material layer 106 is formed on a surface of the substrate 105. The active material layer 106 may be formed on some parts of inner walls of multiple pores or may be formed on substantially all parts of inner walls of the pores.

The second solid electrolyte 107 may contain a halide solid electrolyte, and the halide solid electrolyte is substantially free of sulfur. In this description, a halide solid electrolyte refers to a solid electrolyte containing a halogen element. The halide solid electrolyte may contain oxygen in addition to the halogen element. The halide solid electrolyte is free of sulfur (S).

The second solid electrolyte 107 may contain a sulfide solid electrolyte. Here, in this description, a sulfide solid electrolyte refers to a solid electrolyte containing sulfur (S). The sulfide solid electrolyte may contain a halogen element in addition to sulfur.

The second solid electrolyte 107 may contain an oxide solid electrolyte, a polymeric solid electrolyte, or a complex hydride solid electrolyte.

Examples of the halide solid electrolyte, the sulfide solid electrolyte, the oxide solid electrolyte, the polymeric solid electrolyte, and the complex hydride solid electrolyte that can be used in the second solid electrolyte 107 are respectively the same as the examples of the halide solid electrolyte, the sulfide solid electrolyte, the oxide solid electrolyte, the polymeric solid electrolyte, and the complex hydride solid electrolyte that can be used in the first solid electrolyte contained in the solid electrolyte layer 102 described below.

### First Current Collector

In the battery 1000 of the present embodiment, the first current collector 100 is optional. The first current collector 100 is, for example, in contact with the first electrode 101. The first current collector 100 is, for example, in contact with the substrate 105 of the first electrode 101. Electricity can be highly efficiently obtained from the battery 1000 by including the first current collector 100.

The material for the first current collector 100 is, for example, an elemental metal or an alloy. More specifically, an elemental metal or an alloy that contains at least one selected from the group consisting of copper, chromium, nickel, titanium, platinum, gold, aluminum, tungsten, iron, and molybdenum may be used. The first current collector 100 may be composed of stainless steel.

The first current collector 100 may contain at least one selected from the group consisting of copper (Cu) and nickel (Ni).

The first current collector 100 may have a plate shape or a foil shape. From the viewpoint of ease of securing high conductivity, the first current collector 100 may be a metal foil. The thickness of the first current collector 100 may be, for example, greater than or equal to 5 μm and less than or equal to 20 μm.

The first current collector 100 may be a multilayer film.

### Solid Electrolyte Layer

A halide solid electrolyte, a sulfide solid electrolyte, an oxide solid electrolyte, a polymeric solid electrolyte, or a complex hydride solid electrolyte may be used as the first solid electrolyte contained in the solid electrolyte layer 102.

The first solid electrolyte may contain a halide solid electrolyte.

The halide solid electrolyte may be, for example, a material represented by compositional formula (1) below:

Li_{α}M_{β}X_{γ} Formula (1):

Here, α, β, and γ are each a value greater than 0, M is at least one selected from the group consisting of metalloids and metal elements other than Li, and X is at least one selected from the group consisting of F, Cl, Br, and I.

The “metalloids” are B, Si, Ge, As, Sb, and Te.

The “metal elements” are all group 1 to 12 elements other than hydrogen in the periodic table and all group 13 to 16 elements other than B, Si, Ge, As, Sb, Te, C, N, P, O, S, and Se. In other words, these are a group of elements that can form cations in forming an inorganic compound with a halogen element.

In formula (1), M may contain Y and X may contain Cl and Br.

Examples of the halide solid electrolyte that can be used include Li₃(Ca,Y,Gd)X₆, Li₂MgX₄, Li₂FeX₄, Li(Al,Ga,In)X₄, Li₃(Al,Ga,In)X₆, and LiI. Here, in these solid electrolytes, the element X is at least one selected from the group consisting of F, Cl, Br, and I. In the present disclosure, when the element in a formula is indicated as “(Al,Ga,In)”, this means at least one element selected from the group of elements in the parentheses. In other words, “(Al,Ga,In)” has the same meaning as the “at least one selected from the group consisting of Al, Ga, and In”. The same applies to other elements.

Another example of the halide solid electrolyte is a compound represented by LiₐMe_{b}Y_{c}X₆. Here, a+mb+3c=6 and c>0. Me is at least one selected from the group consisting of metalloids and metal elements other than Li and Y. Here, m represents the valence of Me. The “metalloids” are B, Si, Ge, As, Sb, and Te. The “metal elements” are all group 1 to 12 elements (excluding hydrogen) in the periodic table and all group 13 to 16 elements (excluding B, Si, Ge, As, Sb, Te, C, N, P, O, S, and Se) in the periodic table.

In order to increase the ion conductivity of the halide solid electrolyte material, Me may be at least one selected from the group consisting of Mg, Ca, Sr, Ba, Zn, Sc, Al, Ga, Bi, Zr, Hf, Ti, Sn, Ta, and Nb. The halide solid electrolyte may be Li₃YCl₆, Li₃YBr₆, or Li₃YBrₚCl₆₋ₚ. Here, p satisfies 0<p<6.

The first solid electrolyte may contain a sulfide solid electrolyte.

Examples of the sulfide solid electrolyte that can be used include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂.

Examples of the oxide solid electrolyte include NASICON solid electrolytes such as LiTi₂(PO₄)₃ and element substitution products thereof, perovskite solid electrolytes based on (LaLi)TiO₃, LISICON solid electrolytes such as Li₁₄ZnGe₄O₁₆, Li₄SiO₄, LiGeO₄, and element substitution products thereof, garnet solid electrolytes such as Li₇La₃Zr₂Oi₂ and element substitution products thereof, Li₃PO₄ and N substitution products thereof, and glass or glass ceramic based on a Li—B—O compound such as LiBO₂ or Li₃BO₃ doped with Li₂SO₄, Li₂CO₃, or the like.

The polymeric solid electrolyte can be, for example, a compound between a polymer compound and a lithium salt. The polymer compound may have an ethylene oxide structure. The polymer compound having an ethylene oxide structure can contain a large amount of lithium salts. Thus, the ion conductivity can be further increased. Examples of the lithium salt that can be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from among the aforementioned lithium salts can be used alone. Alternatively, a mixture of two or more lithium salts selected from among the aforementioned lithium salts can be used.

Examples of the complex hydride solid electrolyte that can be used include LiBH₄—LiI and LiBH₄—P₂S₅.

The solid electrolyte layer 102 may contain a halide solid electrolyte. The halide solid electrolyte is free of sulfur.

The solid electrolyte layer 102 may consist essentially of a halide solid electrolyte. In the present description, “consist essentially of” intends to allow inclusion of impurities at a content less than 0.1%. The solid electrolyte layer 102 may consist of a halide solid electrolyte.

The aforementioned features can increase the ion conductivity of the solid electrolyte layer 102. As a result, the decrease in energy density of the battery can be reduced.

The solid electrolyte layer 102 may further contain a binder. The same materials as the materials that can be used in the active material layer 106 can be used as the binder.

The solid electrolyte layer 102 may have a thickness greater than or equal to 1 μm and less than or equal to 500 μm. When the solid electrolyte layer 102 has a thickness greater than or equal to 1 μm, short circuiting between the first electrode 101 and the second electrode 103 rarely occurs. When the solid electrolyte layer 102 has a thickness less than or equal to 500 μm, the battery can operate at high output.

The shape of the solid electrolyte is not particularly limited. When the solid electrolyte is a powder material, the shape thereof may be, for example, a needle shape, a spherical shape, or an oval shape. For example, the solid electrolyte may have a particle shape.

When the solid electrolyte has a particle shape (for example, a spherical shape), the median diameter of the solid electrolyte may be less than or equal to 100 μm or less than or equal to 10 μm.

In the present disclosure, the “median diameter” refers to the particle diameter at which the accumulated volume in a volume-based particle size distribution is 50%. The volume-based particle size distribution is, for example, measured by a laser diffraction measuring instrument or an image analyzer.

The solid electrolyte contained in the solid electrolyte layer 102 can be prepared by the following method.

Raw material powders are prepared so that a desired composition is achieved. Examples of the raw material powders include an oxide, a hydroxide, a halide, and an acid halide.

In one example where the desired composition is Li₃YBr₄Cl₂, LiBr, YCl, and YBr are mixed at a molar ratio of about 3:0.66:0.33. In order to cancel out compositional changes that could happen in the synthetic process, the raw material powder may be mixed at a preliminarily adjusted molar ratio.

The raw material powders are mechanochemically reacted with one another in a mixer such as a planetary ball mill (in other words, by a mechanochemical milling method) so as to obtain a reaction product. The reaction product may be heat-treated in vacuum or in an inert atmosphere. Alternatively, a mixture of raw material powders may be heat-treated in vacuum or in an inert atmosphere to obtain a reaction product. The heat treatment is desirably performed at a temperature higher than or equal to 100° C. and lower than or equal to 300° C. for 1 hour or longer. In order to suppress compositional changes during heat treatment, the raw material powders are desirably heat-treated in a sealed container such as a quartz tube.

A solid electrolyte of the solid electrolyte layer 102 is obtained by the method described above.

### Second Electrode

The second electrode 103 functions as a positive electrode. The second electrode 103 contains a material that can intercalate and deintercalate metal ions such as lithium ions. This material is, for example, a positive electrode active material.

The second electrode 103 contains a positive electrode active material. When the battery 1000 of the present embodiment includes a second current collector 104, the second electrode 103 is disposed between, for example, the second current collector 104 and the solid electrolyte layer 102.

The second electrode 103 may be disposed on a surface of the second current collector 104 to be in direct contact with the second current collector 104.

Examples of the positive electrode active material that can be used include lithium-containing transition metal oxides, transition metal fluorides, polyanion materials, fluorinated polyanion materials, transition metal sulfides, transition metal oxysulfides, and transition metal oxynitrides.

Examples of the lithium-containing transition metal oxides include LiNi_{1-x-y}CoₓAl_{y}O₂ ((x+y)<1), LiNi_{1-x-y}CoₓMn_{y}O₂ ((x+y)<1), and LiCoO₂. In particular, when a lithium-containing transition metal oxide is used as the positive electrode active material, the production cost of the electrode can be reduced, and the average discharge voltage of the battery can be increased. For example, the positive electrode active material may contain Li(Ni,Co,Mn)O₂.

The second electrode 103 may contain a solid electrolyte. The solid electrolytes that are described as examples of the material constituting the solid electrolyte layer 102 may be used as this solid electrolyte.

The positive electrode active material may have a median diameter greater than or equal to 0.1 μm and less than or equal to 100 μm. When the positive electrode active material has a median diameter greater than or equal to 0.1 μm, the positive electrode active material and the solid electrolyte can create a good dispersion state. As a result, the charge-discharge characteristics of the battery are improved. When the positive electrode active material has a median diameter less than or equal to 100 μm, the lithium diffusion speed is improved. As a result, the battery can operate at high output.

The positive electrode active material may have a median diameter greater than that of the solid electrolyte. In this manner, the positive electrode active material and the solid electrolyte can form an excellent dispersion state.

From the viewpoint of the energy density and output of the battery, in the second electrode 103, the ratio of the volume of the positive electrode active material to the total of the volume of the positive electrode active material and the volume of the solid electrolyte may be greater than or equal to 0.30 and less than or equal to 0.95.

In order to prevent the solid electrolyte from reacting with the positive electrode active material, a coating layer may be formed on the surface of the positive electrode active material. In this manner, the increase in reaction overvoltage of the battery can be reduced. Examples of the coating material contained in the coating layer include sulfide solid electrolytes, oxide solid electrolytes, and halide solid electrolytes.

The thickness of the second electrode 103 may be greater than or equal to 10 μm and less than or equal to 500 μm. When the thickness of the second electrode 103 is greater than or equal to 10 μm, a sufficient battery energy density can be secured. When the thickness of the second electrode 103 is less than or equal to 500 μm, the battery can operate at high output.

The second electrode 103 may contain a conductive material to increase electron conductivity.

The second electrode 103 may contain a binder.

The same materials as the materials that can be used in the active material layer 106 can be used as the conductive material and the binder.

For the purpose of facilitating lithium-ion exchange and improving the output characteristics of the battery, the second electrode 103 may contain a nonaqueous electrolyte solution, a gel electrolyte, or an ionic liquid.

The nonaqueous electrolyte solution contains a nonaqueous solvent and a lithium salt dissolved in the nonaqueous solvent. Examples of the nonaqueous solvent include cyclic carbonate solvents, linear carbonate solvents, cyclic ether solvents, linear ether solvents, cyclic ester solvents, linear ester solvents, and fluorine solvents. Examples of the cyclic carbonate solvents include ethylene carbonate, propylene carbonate, and butylene carbonate. Examples of the linear carbonate solvents include dimethyl carbonate, ethyl methyl carbonate, and diethyl carbonate. Examples of the cyclic ether solvents include tetrahydrofuran, 1,4-dioxane, and 1,3-dioxolane. Examples of the linear ether solvents include 1,2-dimethoxyethane and 1,2-diethoxyethane. An example of the cyclic ester solvents is γ-butyrolactone. An example of the linear ester solvents is methyl acetate. Examples of the fluorine solvents include fluoroethylene carbonate, methyl fluoropropionate, fluorobenzene, fluoroethyl methyl carbonate, and fluorodimethylene carbonate. One non-aqueous solvent selected from these may be used alone. Alternatively, a mixture of two or more non-aqueous solvents selected from among these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from among these may be used. The lithium salt concentration is, for example, greater than or equal to 0.5 mol/L and less than or equal to 2 mol/L.

A polymer material impregnated with a non-aqueous electrolyte solution can be used as the gel electrolyte. Examples of the polymer material include polyethylene oxide, polyacrylonitrile, polyvinylidene fluoride, polymethyl methacrylate, and polymers having ethylene oxide bonds.

Examples of the cations contained in the ionic liquid include: (i) aliphatic linear quaternary salts such as tetraalkylammonium and tetraalkylphosphonium; (ii) aliphatic cyclic ammoniums such as pyrrolidiniums, morpholiniums, imidazoliniums, tetrahydropyrimidiniums, piperaziniums, and piperidiniums; and (iii) nitrogen-containing heterocyclic aromatic cations such as pyridiniums and imidazoliums.

Examples of the anion contained in the ionic liquid include PF₆⁻, BF₄⁻, SbF₆⁻, AsF₆⁻, SO₃CF₃—, N(SO₂CF₃)₂—, N(SO₂C₂F₅)₂⁻, N(SO₂CF₃)(SO₂C₄F₉)⁻, and C(SO₂CF₃)₃⁻.

The ionic liquid may contain a lithium salt.

Although the structure example in which the first electrode 101 is a negative electrode and the second electrode 103 is a positive electrode has been described heretofore, the first electrode 101 may be a positive electrode and the second electrode 103 may be a negative electrode.

When the first electrode 101 is a positive electrode and the second electrode 103 is a negative electrode, the active material layer 106 is a positive electrode active material layer. In other words, Bi contained in the active material layer 106 functions as a positive electrode active material. In such a case, the second electrode 103 serving as a negative electrode is made of, for example, lithium metal.

### Second Current Collector

In the battery 1000 of the present embodiment, the second current collector 104 is optional. The second current collector 104 is, for example, in contact with the second electrode 103. Electricity can be highly efficiently obtained from the battery 1000 by including the second current collector 104.

The material for the second current collector 104 is, for example, an elemental metal or an alloy. More specifically, an elemental metal or an alloy that contains at least one selected from the group consisting of copper, chromium, nickel, titanium, platinum, gold, aluminum, tungsten, iron, and molybdenum may be used. The second current collector 104 may be composed of stainless steel.

The second current collector 104 may contain nickel (Ni).

The second current collector 104 may have a plate shape or a foil shape. From the viewpoint of ease of securing high conductivity, the second current collector 104 may be a metal foil. The thickness of the second current collector 104 may be, for example, greater than or equal to 5 μm and less than or equal to 20 μm.

The second current collector 104 may be a multilayer film.

The battery 1000 includes the first electrode 101, the solid electrolyte layer 102, and the second electrode 103 as the basic features, and is enclosed in a sealed container so that air and moisture would not mix in. Examples of the shape of the battery 1000 include a coin shape, a cylinder shape, a prism shape, a sheet shape, a button shape, a flat shape, and a multilayer shape.

### EXAMPLES

In the description below, the details of the present disclosure are disclosed through Examples and Reference Examples. Examples described below are merely illustrative, and do not limit the present disclosure.

### Example 1

### Preparation of First Electrode

After a nickel mesh (10 cm×10 cm, thickness: 50 μm, “NI-318200” produced by The Nilaco Corporation) was preliminarily degreased with an organic solvent as a preliminary treatment, the nickel mesh was immersed in an acidic solvent to perform degreasing and activate the nickel mesh surface. To 1.0 mol/L methanesulfonic acid, bismuth methanesulfonate serving as a soluble bismuth salt was added so that the Bi³⁺ ion concentration was 0.18 mol/L so as to prepare a plating bath. The activated nickel mesh was connected to a power supply so that current could be applied, and then immersed in the plating bath. Next, the nickel mesh surface was electroplated with Bi by controlling the current density to 2 A/dm² so that the thickness of the plating layer was about 5 μm. After the electroplating, the nickel mesh was recovered from the acidic bath, washed with pure water, and dried. The Bi plating mass on the nickel mesh was 1.032 g.

### Preparation of Solid Electrolyte

In an argon atmosphere having a dew point lower than or equal to −60° C. (hereinafter referred to as a “dry argon atmosphere”), the raw material powders, LiBr, YCl₃, and YBr₃, were prepared at a molar ratio of LiBr:YCl₃:YBr₃=3:2/3:1/3. These raw material powders were crushed and mixed in a mortar into a mixed powder. The obtained mixture of the raw material powders was heat-treated in a dry argon atmosphere in an electric furnace at 500° C. for 3 hours, as a result of which a heat-treated product was obtained. The obtained heat-treated product was crushed with a pestle in a mortar. As a result, a solid electrolyte having a composition represented by Li₃YBr₄Cl₂ was obtained.

### Preparation of Test Cell

In an insulating external cylinder having an inner diameter of 9.4 mm, a solid electrolyte Li₃YBr₄Cl₂ (80 mg) was stacked on the obtained first electrode serving as a working electrode, and then an indium-lithium alloy (molar ratio In:Li=1:1) (200 mg) was stacked as a counter electrode to form a multilayer body. The indium-lithium alloy was prepared by pressing a small piece of a lithium foil onto an indium foil and diffusing lithium into indium. A pressure of 360 MPa was applied to the multilayer body to form a working electrode, a solid electrolyte layer, and a counter electrode. In the multilayer body, the thickness of the first electrode serving as a working electrode was 65 μm, the thickness of the solid electrolyte layer was 400 μm, and the thickness of the counter electrode was 15 μm.

Next, current collectors made from stainless steel were attached to the working electrode and the counter electrode, and current collecting leads were attached to the current collectors.

Lastly, the inside of the insulating external cylinder was shut out from the external atmosphere by using an insulating ferrule to seal the inside of the cylinder.

As a result, a test cell of Example 1 in which the working electrode was the electrode (that is, the first electrode) obtained by forming a Bi active material layer on the nickel mesh and the counter electrode was made of a lithium-indium alloy was obtained. Here, the prepared test cell is a unipolar test cell that uses a working electrode and a counter electrode, and is used to test performance of one of the electrodes in a secondary battery. To be more specific, an electrode to be tested is used as the working electrode, and an active material in an amount sufficient for the reaction at the working electrode is used in the counter electrode. Since the present test cell was used to test the performance of the first electrode serving as a negative electrode, a large excess of a lithium-indium alloy was used as the counter electrode as with the usual practice. The negative electrode performance of which was tested using such a test cell can be used in a secondary battery when used together with a positive electrode that contains the positive electrode active material mentioned in the above-described embodiments, for example, a transition metal oxide containing Li.

### Charge-Discharge Cycle Test

A charge-discharge test of the prepared test cell was conducted under the following conditions. Assuming that the theoretical capacity of Bi is 384 mAh/g from the mass of electroplated Bi, constant-current charging was carried out to 0 V (0.62 V vs Li⁺/Li) at a rate of 0.1 IT on a Bi basis, and then discharging was carried out to 1.38 V (2.0 V vs Li⁺/Li). The charge-discharge test of the test cell was performed in a 25° C. constant temperature oven. FIG. 4 is a graph showing the results of the charge-discharge test of the test cell of Example 1. The test cell of Example 1 maintained the initial discharge capacity even after 50 charge-discharge cycles.

### Example 2

### Preparation of First Electrode

After a porous nickel (10 cm×10 cm, thickness: 1.6 mm, “NI-318161” produced by The Nilaco Corporation) was preliminarily degreased with an organic solvent as a preliminary treatment, the porous nickel was immersed in an acidic solvent to perform degreasing and activate the porous nickel surface. To 1.0 mol/L methanesulfonic acid, bismuth methanesulfonate serving as a soluble bismuth salt was added so that the Bi³⁺ ion concentration was 0.18 mol/L so as to prepare a plating bath. The activated porous nickel was connected to a power supply so that current could be applied, and then immersed in the plating bath. Next, the porous nickel surface was electroplated with Bi by controlling the current density to 2 A/dm² so that the thickness of the plating layer was about 5 μm. After the electroplating, the porous nickel was recovered from the acidic bath, washed with pure water, and dried. The Bi plating mass on the porous nickel was 0.526 g.

### Preparation of Solid Electrolyte

A solid electrolyte having a composition represented by Li₃YBr₄Cl₂ was obtained as in Example 1.

### Preparation of Test Cell

A first electrode of Example 2 that had a structure in which an active material layer 106 composed of Bi was formed on a substrate 105 made of a porous nickel was used as the first electrode. A test cell of Example 2 was obtained as with the test cell of Example 1 except for this point. The thickness of the first electrode serving as a working electrode was 400 μm, the thickness of the solid electrolyte layer was 400 μm, and the thickness of the counter electrode was 15 μm.

### Charge-Discharge Cycle Test

A charge-discharge test of the prepared test cell of Example 2 was conducted under the same conditions as in Example 1. FIG. 4 is a graph showing the results of the charge-discharge test of the test cell of Example 2. The test cell of Example 2 maintained the initial discharge capacity even after 50 charge-discharge cycles.

### Reference Example 1

### Preparation of First Electrode

After a nickel mesh (10 cm×10 cm, thickness: 50 μm, “NI-318200” produced by The Nilaco Corporation) was preliminarily degreased with an organic solvent as a preliminary treatment, the nickel mesh was immersed in an acidic solvent to perform degreasing and activate the nickel mesh surface. To 1.0 mol/L methanesulfonic acid, bismuth methanesulfonate serving as a soluble bismuth salt was added so that the Bi³⁺ ion concentration was 0.18 mol/L so as to prepare a plating bath. The activated nickel mesh was connected to a power supply so that current could be applied, and then immersed in the plating bath. Next, the nickel mesh surface was electroplated with Bi by controlling the current density to 2 A/dm² so that the thickness of the plating layer was about 5 μm. After the electroplating, the nickel mesh was recovered from the acidic bath, washed with pure water, and dried. The Bi plating mass on the nickel mesh was 1.032 g. The plated nickel mesh was punched out into a 2 cm×2 cm piece to obtain a first electrode.

### Preparation of Test Cell

The first electrode was used as the working electrode. A Li metal having a thickness of 0.34 μm was used as the counter electrode. The Li metal was double coated with a microporous separator (Celgard 3401 produced by Asahi Kasei Corporation). A solution prepared by dissolving LiPF₆ in vinylene carbonate (VC) at a concentration of 1.0 mol/L was prepared as the electrolyte solution. As a result, a test cell of Reference Example 1 was obtained.

### Charge-Discharge Cycle Test

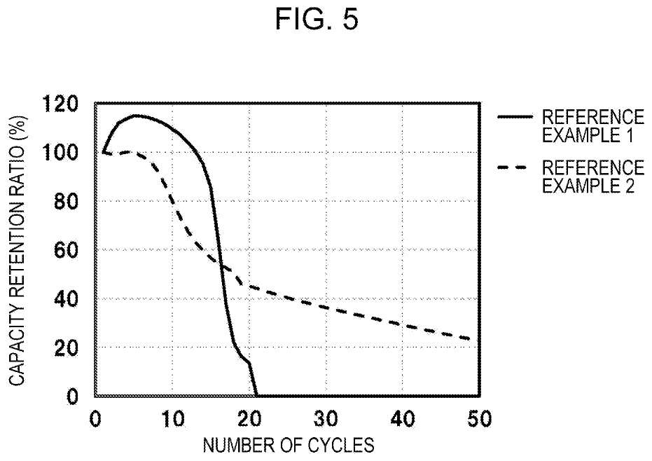

The test cell of Reference Example 1 was charged at a constant current of 2 mA to 0 V (vs Li⁺/Li) and then discharged to 2.0 V (vs Li⁺/Li). This cycle was assumed to constitute one cycle, and the charge-discharge cycle test was performed 21 cycles. The battery was tested in a 25° C. constant temperature oven. FIG. 5 is a graph showing the results of the charge-discharge test of the test cell of Reference Example 1. The discharge capacity of the test cell of Reference Example 1 after 20 charge-discharge cycles decreased to 20% or less of the initial discharge capacity.

### Reference Example 2

### Preparation of First Electrode

After a porous nickel (10 cm×10 cm, thickness: 1.6 mm, “NI-318161” produced by The Nilaco Corporation) was preliminarily degreased with an organic solvent as a preliminary treatment, the porous nickel was immersed in an acidic solvent to perform degreasing and activate the porous nickel surface. To 1.0 mol/L methanesulfonic acid, bismuth methanesulfonate serving as a soluble bismuth salt was added so that the Bi³⁺ ion concentration was 0.18 mol/L so as to prepare a plating bath. The activated porous nickel was connected to a power supply so that current could be applied, and then immersed in the plating bath. Next, the porous nickel surface was electroplated with Bi by controlling the current density to 2 A/dm² so that the thickness of the plating layer was about 5 μm. After the electroplating, the porous nickel was recovered from the acidic bath, washed with pure water, and dried. The Bi plating mass on the porous nickel was 0.526 g. The plated porous nickel was punched out into a 2 cm×2 cm piece to obtain a first electrode.

### Preparation of Test Cell

The first electrode was used as the working electrode. A Li metal having a thickness of 0.34 μm was used as the counter electrode. The Li metal was double coated with a microporous separator (Celgard 3401 produced by Asahi Kasei Corporation). A solution prepared by dissolving LiPF₆ in vinylene carbonate (VC) at a concentration of 1.0 mol/L was prepared as the electrolyte solution. As a result, a test cell of Reference Example 2 was obtained.

### Charge-Discharge Cycle Test

The test cell of Reference Example 2 was charged at a constant current of 10 mA to 0 V (vs Li⁺/Li) and then discharged to 2.0 V (vs Li⁺/Li). This cycle was assumed to constitute one cycle, and the charge-discharge cycle test was performed 50 cycles. The battery was tested in a 25° C. constant temperature oven. FIG. 5 is a graph showing the results of the charge-discharge test of the test cell of Reference Example 2. The discharge capacity of the test cell of Reference Example 1 after 20 charge-discharge cycles decreased to 20% or less of the initial discharge capacity.

These results show that a battery in which a solid electrolyte is used in combination with an electrode that uses a porous body serving as a substrate and contains Bi as an active material exhibits higher discharge capacity retention ratio in the charge-discharge cycle test compared to a battery in which an electrolyte solution is used. In other words, the battery of the present disclosure equipped with a first electrode that included a substrate including a porous body, and a Bi-containing active material layer on a surface of the substrate, and a solid electrolyte layer was confirmed to have a structure suitable for improving the charge-discharge cycles.

Although a halide solid electrolyte Li₃YBr₄Cl₂ was used as the solid electrolyte in Examples in this description, the same effects can be expected from other typical solid electrolytes as well.

The battery of the present disclosure can be applied to, for example, an all-solid lithium secondary battery.

What is claimed is:

1. A battery comprising:
a first electrode;
a second electrode; and
a solid electrolyte layer disposed between the first electrode and the second electrode,
wherein the solid electrolyte layer contains a first solid electrolyte,
the first electrode includes:
a substrate including a porous body; and
an active material layer disposed on a surface of the substrate,
the active material layer contains Bi, and
the first solid electrolyte contains a halide solid electrolyte.

2. The battery according to claim 1, wherein the active material layer contains elemental Bi.

3. The battery according to claim 1, wherein the active material layer contains the Bi as a main component of an active material.

4. The battery according to claim 3, wherein the active material layer contains substantially only the Bi as the active material.

5. The battery according to claim 1, wherein the active material layer contains at least one selected from the group consisting of LiBi and Li₃Bi.

6. The battery according to claim 1, wherein the active material layer is free of an electrolyte.

7. The battery according to claim 1, wherein the substrate contains at least one selected from the group consisting of Cu and Ni.

8. The battery according to claim 1, wherein the active material layer is a plating layer.

9. The battery according to claim 1, wherein the halide solid electrolyte is substantially free of sulfur.

10. The battery according to claim 1, wherein the first solid electrolyte contains a sulfide solid electrolyte.

11. The battery according to claim 1, wherein the first electrode further includes a second solid electrolyte in contact with the active material layer.

12. The battery according to claim 1, wherein the first electrode is a negative electrode and the second electrode is a positive electrode.
